(19) United States
(12) Patent Application Publication
(10) Pub. No.: US 2007/0133486 A1
(43) Pub. Date: Jun. 14, 2007

(54) Data pre-provisioning plan method and apparatus

(76) Inventors: Sivakumar Muthuswamy, Tower Lakes, IL (US); Thomas C. Hill, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 11/301,509

(22) Filed: Dec. 13, 2005

(51) Int. Cl. H04Q 7/24

(52) U.S. Cl. 370/338

(57) ABSTRACT

A plurality of potential receiving locations where a target recipient may be able to receive at least a portion of data that has been provided (101) for transmission to that target recipient are determined (102). A pre-provisioning plan is then developed (103) to provide at least a portion of that data to the target recipient as a function, at least in part, of at least one of time and the target recipient's likely movement with respect to the plurality of potential receiving locations. More particularly, this pre-provisioning plan can comprise, at least in part, pre-provisioning at least one of the potential receiving locations with at least some of the data in anticipation of the target recipient's movement over time.

### TECHNICAL FIELD

This invention relates generally to communications and more particularly to the conveyance of data to a target recipient.

### BACKGROUND

Communication systems of various kinds are known in the art. At present there are numerous communication systems, including wireless communication systems, available for use with many more planned for relatively near term deployment. Some of these communication systems offer a single point of attachment to be used by client devices while others offer a plurality of attachment points. When multiple attachment points are offered, as in a modern cellular telephony network, the multiple attachment points are often geographically distributed though sometimes the bearer technology will vary from point to point as well.

Such systems support the transport of various kinds of data including both file delivery services and real time services (such as streaming content services). When a recipient client device remains stationary the delivery of such services can sometimes be realized by using a best-available point of attachment and/or by simply relying upon whatever attachment point/technology a corresponding user may have selected. Increasingly, however, client devices exhibit mobility. Modern systems increasingly support such mobility by supporting handoffs (both between points of attachment within a given network and also as between points of attachment for differing networks).

The above circumstances present issues with respect to the efficient and timely delivery of data services to a given client device. In addition, the ever-increasing bulk of data payloads (for such things as audio and video files) can acerbate such concerns. As a given client device moves it may be impossible from time to time to complete the delivery of a given data payload to that client device using an initial point of attachment. This, in turn, can lead to frustrated users who increasingly expect a relatively transparent and immediate experience when interacting with their communication devices.

### BRIEF DESCRIPTION OF THE DRAWINGS

The above needs are at least partially met through provision of the data pre-provisioning plan method and apparatus described in the following detailed description, particularly when studied in conjunction with the drawings, wherein:

FIG. 1 comprises a flow diagram as configured in accordance with various embodiments of the invention;

FIG. 2 comprises a top plan schematic view as configured in accordance with various embodiments of the invention;

FIG. 3 comprises a top plan schematic view as configured in accordance with various embodiments of the invention.

FIG. 4 comprises a top plan schematic view as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one determines a plurality of potential receiving locations where a target recipient may be able to receive at least a portion of data that has been provided for transmission to that target recipient. A pre-provisioning plan is then developed to provide at least a portion of that data to the target recipient as a function, at least in part, of at least one of time and the target recipient's likely movement with respect to the plurality of potential receiving locations. More particularly, this pre-provisioning plan can comprise, at least in part, pre-provisioning at least one of the potential receiving locations with at least some of the data in anticipation of the target recipient's movement over time.

These teachings can be deployed and leveraged in a variety of ways. By one approach varying amounts and/or varying degrees of redundant content can be pre-provisioned in this manner with respect to a plurality of potential receiving locations. If desired, one may also develop and/or implement a data deletion plan to provide for deleting all or portions of such pre-provisioned data as a function, for example, of time and/or the target recipient's actual movement with respect to the plurality of receiving locations.

So configured, these teachings permit data to be placed ahead of a target recipient's movements to thereby render that content more immediately available for downloading to the target recipient. This capability can also be employed, for example, to facilitate using higher bandwidth bearer technologies when potentially available to the benefit of the user. Notwithstanding these benefits, these teachings also permit such pre-provisioning to be effected in a calculated and careful manner to thereby avoid overloading potential receiving locations with undue quantities of data.

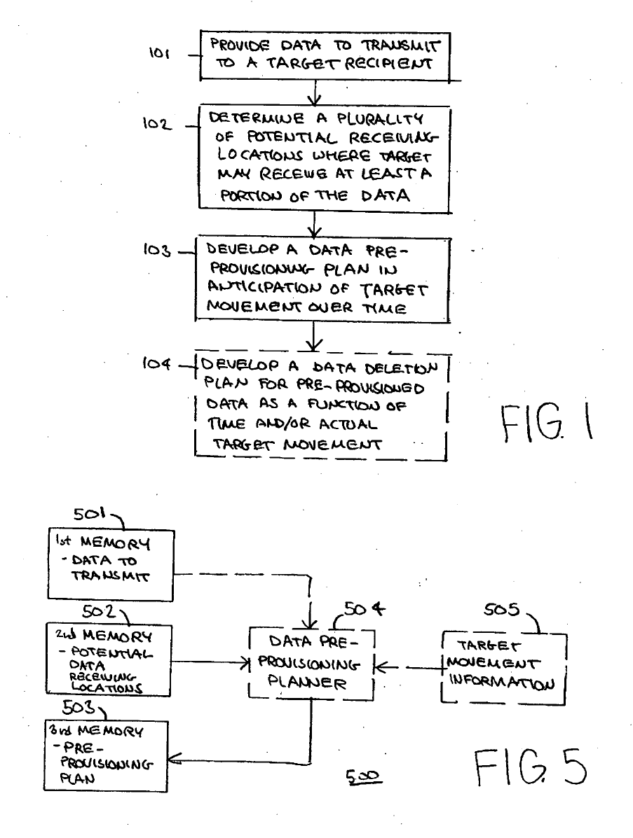

These and other benefits may become clearer upon making a thorough review and study of the following detailed description. Referring now to the drawings, and in particular to FIG. 1, a corresponding illustrative process 100 makes provision for providing 101 data to be transmitted to a target recipient (such as, but not limited to, a wireless communication station). As noted earlier, such data can comprise essentially any content including both real time and non-real time content. This data can also comprise a single complete file or work or can comprise an aggregation of different discrete content to be provided to the target recipient as desired. In many cases, this data will comprise a relatively large quantity of data that cannot likely be transmitted to the target recipient over only a relatively short period of time (and if desired, effecting this process 100 can be made contingent upon detecting such a circumstance).

This process 100 also provides for determining 102 a plurality of potential receiving locations where the target recipient may be able to receive at least a portion of the data. These potential receiving locations may, or may not, be part of a common communication network. By one approach, for example, the communication opportunities may comprise a homogeneous opportunity where each potential receiving location is part of a same network (such as a wide area network such as a cellular telephony network or the like).

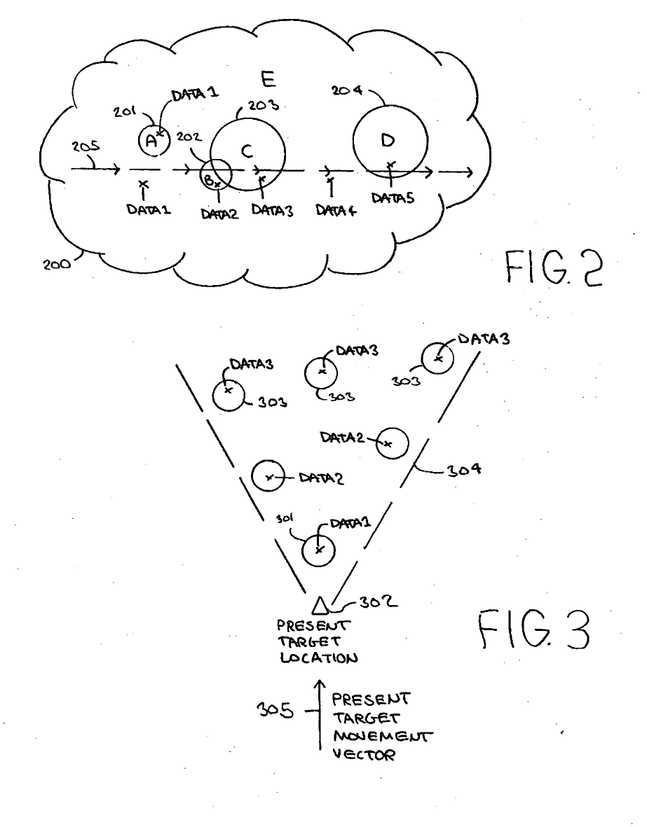

By another approach, the available communication opportunities may represent a heterogeneous construct where at least some of the potential receiving locations are not part of the same network. For example, to illustrate (and referring momentarily to FIG. 2), a given such plurality of potential receiving locations for a given target recipient (not shown) may include multiple base stations (not shown) as comprise a part of a cellular communication system 200, two 802.11-family so-called wi-fi networks A 201 and B 202, an 802.16-family wireless network C 203, and an 802.20-family wireless network D 204. (As such networks are already well understood in the art and as these teachings are relatively insensitive to the selection of any particular bearer technology, no further elaboration regarding such networks need be provided here.)

There are various ways to determine such potential receiving locations. By one approach one simply identifies all receiving locations that a given target recipient might possibly encounter within some given period of time. This might include, for example, all receiving locations within a given radius of the target recipient's present location. By another approach one tends towards trying to anticipate a particular direction of travel for the target recipient and to identify receiving locations that are coincident with that anticipated direction of travel. Such anticipation can be based upon any of a wide variety of factors including, but not limited to:
a present detected or reported travel vector;
a communicated travel vector (as when a given user provides specific information regarding an anticipated or planned direction and/or schedule of travel);
a historical record of travel as corresponds to this target recipient.

This process 100 then provides for developing 103 a pre-provisioning plan to provide at least a portion of the data to the target recipient as a function, at least in part, of at least one of time and the target recipient's likely movement with respect to the plurality of potential receiving locations. This plan may be accordingly based, as desired and/or as appropriate to a given operating circumstance, upon the target recipient's relative lack of movement, movement of the target recipient from a first potential receiving location to a second potential receiving location (where the first and second potential receiving locations differ from one another with respect to available bandwidth that may be applied to support providing the data to the target recipient), relative differences between potential receiving locations with respect to supportable quality of service, relative differences between potential receiving locations with respect to a corresponding cost of content delivery; relative differences between potential receiving locations with respect to wireless communication network loading; relative differences between potential receiving locations with respect to proximity to an original source of the data to be provided, and so forth.

This pre-provisioning plan can be weighted in favor of different considerations as may vary from one system and/or user to another. By one approach, such a pre-provisioning plan can comprise varying amount of data at different potential receiving locations to account for differing bandwidth availabilities and/or differing levels of device mobility at such locations. For example, and referring again to FIG. 2, based upon a known total quantity of data to provide to a given target recipient and based further upon a presently known trajectory 205, a first portion of data DATA1 can be pre-provisioned at a network E 200 base station (not shown) while a second portion of data DATA2 is pre-provisioned at the 802.11-family network B 202. In a similar fashion other data portions DATA3, DATA4, and DATA5 are pre-provisioned at other potential receiving locations as shown.

The amount of data provided in such portions can vary with respect to the available bandwidth at such locations and also with respect to a duration of time that the target recipient may be expected to remain attached to such location. To illustrate, if network C 203 comprised a relatively high bandwidth bearer technology as compared to other of the potential receiving locations, then the amount of data DATA3 pre-provisioned at that location could be relatively higher than the amount pre-provisioned at other of the potential receiving locations.

The pre-provisioning plan can also, if desired, provide for at least partially redundant pre-provisioning. That is, at least partially redundant selections of the data may be pre-provisioned at differing ones of the potential receiving locations. To illustrate with a simple example, and with continued reference to FIG. 2, a first portion of data DATA1 may be pre-provisioned at both the network E 200 base site mentioned earlier and also at an 802.11-family network A 201. In this case, the target recipient would be able to obtain this portion of data DATA1 upon becoming attached to the aforementioned 802.11-family network A 201 or upon bypassing that opportunity and interacting with the network E 200 base site. This could also comprise, of course, placing redundant portions of content at various locations along an expected path for the end user to permit the end user to complete a download of that content portion from a subsequent point of attachment in the event the end user is unable to obtain the complete content portion from an earlier point of attachment.

When pre-provisioning redundant data, these teachings will also permit using a deployment pattern such that a greater number of differing ones of the potential receiving locations are provided with at least partially redundant selections of the data when the potential receiving locations are located further from a likely present position of the target recipient than as is provided when the potential receiving locations are located closer to a likely present location of the target recipient.

To illustrate, and referring momentarily to FIG. 3, while a more limited number of potential receiving locations 301 may have a first portion of data DATA1, more remotely located (with respect to the likely present position of the target 302) potential receiving locations 303 may have redundant pre-provisioned quantities of another portion of data DATA3. For example, in this illustration, only one relatively proximal potential receiving location 301 is pre-provisioned with DATA1 while three relatively distal potential receiving locations 303 are pre-provisioned with DATA3.

This approach can offer particular benefits when used in conjunction with a substantially fan shaped deployment pattern 304 as shown in FIG. 3 (which in turn may be beneficially used when a present (or likely) target movement vector 305 for the target recipient is presently known to some degree of assurance). By this approach, redundant pre-provisioning tends to be used to a greater extent as a specific likelihood of the target recipient having access to that pre-provisioned content becomes relatively lower though still of reasonable likelihood. This, in turn, aids in avoiding undue usage of redundant pre-provisioning when such redundancy is less likely to serve a beneficial purpose.

Other approaches are also compatible for use with these teachings. As but one example in this regard, such a pre-provisioning plan can comprise using a deployment pattern wherein potential receiving locations that are relatively further from a likely present location of the target recipient are each provided with relatively less total data than potential receiving locations that are located relatively closer to the likely present location of the target recipient.

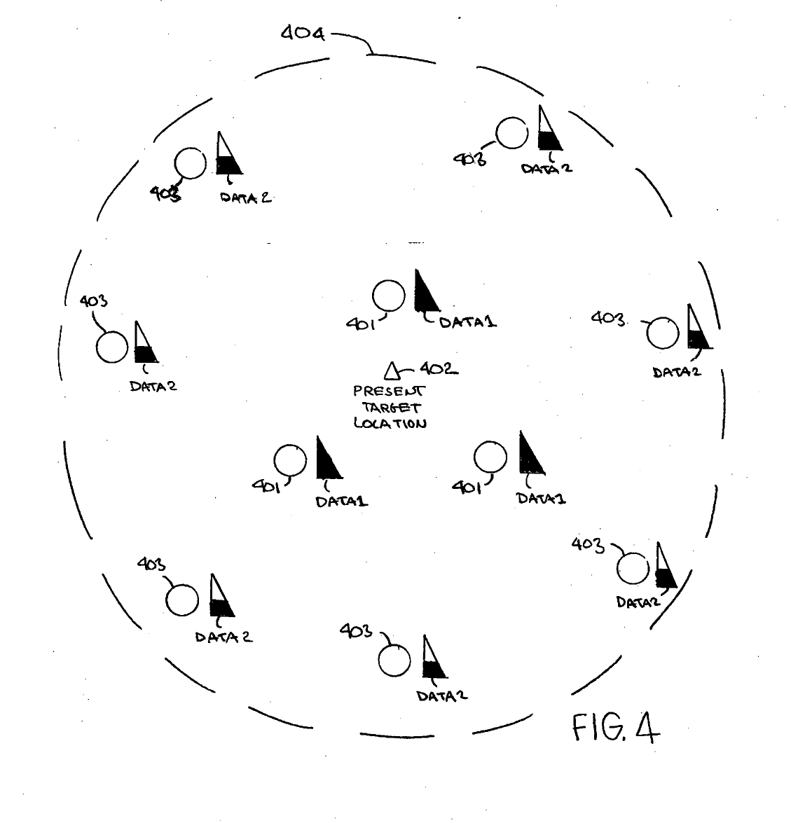

To illustrate this concept, and referring momentarily to FIG. 4, while potential receiving locations 401 that are relatively proximal to a likely present location 402 of a target recipient might be provided with a first quantity of data DATA1, those potential receiving locations 403 as are located more distal to the likely present location 402 of the target recipient are provided with a relatively smaller amount of data DATA2. This approach again aids in preventing at least some potential receiving locations from becoming overburdened with pre-provisioning storage requirements. Such an approach may be particularly useful when deployed in conjunction with a deployment pattern 404 that is substantially circle shaped which in turn is useful at least when applied with respect to a presently non-moving target recipient and/or a target recipient for which a likely trajectory of movement is not known to an acceptable level of assurance.

Returning again to FIG. 1, the development of a pre-provisioning plan can also, if desired, take into account a plurality of target recipients. Where, for example, the provided data is to be transmitted to a plurality of target recipients, developing 103 a pre-provisioning plan can comprise planning to pre-provision at least partially redundant selections of the data at differing ones of the potential receiving locations in anticipation of multiple target recipients each being able to receive the data from at least one of the potential receiving locations.

This process 100 can then also optionally provide for developing 104 a data deletion plan to delete at least a portion of the data as has been pre-provisioned according to the pre-provisioning plan developed above. This data deletion plan can be developed, if desired, as a function, at least in part, of at least one of time and the target recipient's actual movement with respect to the plurality of potential receiving locations. Such a data deletion plan can also take into account, if desired, responding to delivery of specific data portions to the target recipient by a first one of the receiving locations such that redundant examples of that specific data portion are deleted at other receiving locations.

So configured, data as comprises at least a part of a potentially large quantity of data is pre-provisioned at one or more potential receiving locations in anticipation, for example, of movement by a corresponding target recipient with respect to those potential receiving locations. By these teachings such pre-positioning occurs in an informed and thoughtful manner such that undue storage requirements are not put upon all such potential receiving locations in all cases. Instead, redundant distributions and absolute quantities are measured as a function, at least in part, of any of a variety of relevant decision-making criteria including relative distance from a likely present position of the target recipient, relative distance from a likely direction of movement of the target recipient, relative bandwidth capabilities, other potential recipients of the data, and so forth.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

This apparatus 500 can comprise a first, second, and third memory 501, 502, and 503. The first memory 501 can have data stored therein that is to be transmitted to a target recipient as disclosed above. The second memory 502 can have a plurality of potential receiving locations stored therein where the target recipient may be able to receive at least a portion of the data that is stored in the first memory 501. Numerous ways of developing such a plurality of potential receiving locations are set forth above. The third memory 503, in this embodiment, has stored therein a pre-provisioning plan by which at least portions of the aforementioned data can be provided to the target recipient. Again, numerous ways of developing such a pre-provisioning plan are set forth above. If desired, this third memory 503 can have more than one candidate pre-provisioning plan stored therein. So configured, a switch can be made to an alternative pre-provisioning plan should circumstances subsequent to adopting a particular pre-provisioning plan so dictate.

By one approach, if desired, an optional data pre-provisioning planner 504 that operably couples to at least the second and third memories 502 and 503 (and also, optionally, to the first memory 501) can be employed to develop the pre-provisioning plan that is stored in the third memory 503. This data pre-provisioning planner 504 can serve to implement, for example, one or more of the aforementioned pre-provisioning plans as per the various planning criteria set forth above. Such planning can particularly take into account, for example, information 505 regarding the target recipient's movement (which may include information regarding a likely or actual present location of the target recipient).

Those skilled in the art will recognize and understand that such an apparatus 500 may be comprised of a plurality of physically distinct elements as is suggested by the illustration shown in FIG. 5. It is also possible, however, to view this illustration as comprising a logical view, in which case one or more of these elements (such as the memories) can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing data to transmit to a target recipient;
determining a plurality of potential receiving locations where the target recipient may be able to receive at least a portion of the data;
developing a pre-provisioning plan to provide at least a portion of the data to the target recipient as a function, at least in part, of at least one of time and the target recipient's likely movement with respect to the plurality of potential receiving locations, which pre-provisioning plan comprises, at least in part, pre-provisioning at least one of the potential receiving locations with at least some of the data in anticipation of the target recipient's movement over time.

2. The method of claim 1 wherein providing data comprises providing a relatively large quantity of data that cannot likely be transmitted to the target recipient over only a relatively short period of time.

3. The method of claim 1 wherein the target recipient comprises a wireless communication station.

4. The method of claim 1 wherein determining a plurality of potential receiving locations where the target recipient may be able to receive at least a portion of the data comprises determining a plurality of potential receiving locations as comprise a part of a common communication network.

5. The method of claim 1 wherein determining a plurality of potential receiving locations where the target recipient may be able to receive at least a portion of the data comprises determining a plurality of potential receiving locations as comprise parts of different communication networks.

6. The method of claim 1 wherein pre-provisioning at least one of the potential receiving locations with at least some of the data in anticipation of the target recipient's movement over time comprises pre-provisioning at least partially redundant selections of the data at differing ones of the potential receiving locations.

7. The method of claim 6 wherein pre-provisioning at least partially redundant selections of the data at differing ones of the potential receiving locations further comprises pre-provisioning differing amounts of the data at the differing ones of the potential receiving locations.

8. The method of claim 6 wherein pre-provisioning at least partially redundant selections of the data at differing ones of the potential receiving locations further comprises pre-provisioning the data using a deployment pattern such that a greater number of differing ones of the potential receiving locations are provided with at least partially redundant selections of the data when the potential receiving locations are located further from a likely present position of the target recipient than as is provided when the potential receiving locations are located closer to a likely present location of the target recipient.

9. The method of claim 8 wherein the deployment pattern is substantially fan shaped.

10. The method of claim 6 wherein pre-provisioning at least partially redundant selections of the data at differing ones of the potential receiving locations further comprises pre-provisioning the data using a deployment pattern such that potential receiving locations that are relatively further from a likely present location of the target recipient are provided with relatively less total data than potential receiving locations that are located relatively closer to the likely present location of the target recipient.

11. The method of claim 10 wherein the deployment pattern is substantially circle shaped.

12. The method of claim 1 wherein providing data to transmit to a target recipient comprises providing data to transmit to a plurality of target recipients and wherein pre-provisioning at least one of the potential receiving locations with at least some of the data in anticipation of the target recipient's movement over time comprises pre-provisioning at least partially redundant selections of the data at differing ones of the potential receiving locations further comprises pre-provisioning at least one of the potential receiving locations with at least some of the data in anticipation of multiple target recipients each being able to receive the data from at least one of the potential receiving locations.

13. The method of claim 1 further comprising:
developing a data deletion plan to delete at least a portion of the data as has been pre-provisioned according to the pre-provisioning plan as a function, at least in part, of at least one of:
time;
the target recipient's actual movement with respect to the plurality of potential receiving locations.

14. The method of claim 1 wherein developing a pre-provisioning plan to provide at least a portion of the data to the target recipient as a function, at least in part, of at least one of time and the target recipient's likely movement with respect to the plurality of potential receiving locations comprises developing the pre-provisioning plan as a function, at least in part, of at least one of:
the target recipient's relative lack of movement;
movement of the target recipient from a first potential receiving location to a second potential receiving location, wherein the first and second potential receiving location differ from one another with respect to available bandwidth to support providing the data to the target recipient;
relative differences between potential receiving locations with respect to supportable quality of service;
relative differences between potential receiving locations with respect to a corresponding cost of content delivery relative differences between potential receiving locations with respect to loading;
relative differences between potential receiving locations with respect to proximity to an original source of the data to be provided.

15. An apparatus comprising:
a first memory having stored therein data to transmitted to a target recipient;
a second memory having stored therein a plurality of potential receiving locations where the target recipient may be able to receive at least a portion of the data;
a third memory having stored therein a pre-provisioning plan to provide at least a portion of the data to the target recipient as a function, at least in part, of at least one of time and the target recipient's likely movement with respect to the plurality of potential receiving locations, which pre-provisioning pan comprises, at least in part, pre-provisioning at least one of the potential receiving locations with at least some of the data in anticipation of the target recipient's movement over time.

16. The apparatus of claim 15 further comprising means operably coupled to the first, second, and third memory for developing the pre-provisioning plan.

17. The apparatus of claim 15 further comprising a data pre-provisioning planner that is operably coupled to at least the second and third memory and that is configured and arranged to facilitate development of the pre-provisioning plan to provide, at least in part, for pre-provisioning at least partially redundant selections of the data at differing ones of the potential receiving locations.

18. The apparatus of claim 17 wherein the data pre-provisioning planner is further configured and arranged to facilitate development of the pre-provisioning plan to provide, at least in part, for pre-provisioning differing amounts of the data at the differing ones of the potential receiving locations.

19. The apparatus of claim 15 further comprising a data pre-provisioning planner that is operably coupled to at least the second and third memory and that is configured and arranged to facilitate development of the pre-provisioning plan to provide, at least in part, for pre-provisioning the data using a deployment pattern such that a greater number of differing ones of the potential receiving locations are provided with at least partially redundant selections of the data when the potential receiving locations are located further from a likely present position of the target recipient than as is provided when the potential receiving locations are located closer to a likely present location of the target recipient.

20. The apparatus of claim 15 further comprising a data pre-provisioning planner that is operably coupled to at least the second and third memory and that is configured and arranged to facilitate development of the pre-provisioning plan to provide, at least in part, for pre-provisioning the data using a deployment pattern such that potential receiving locations that are relatively further from a likely present location of the target recipient are provided with relatively less total data than potential receiving locations that are located relatively closer to the likely present location of the target recipient.
